(19) United States
(12) Patent Application Publication
(10) Pub. No.: US 2016/0027321 A1
(43) Pub. Date: Jan. 28, 2016

(54) Methods and Software For Providing a Guided Window Tool for Improving Reading Skills

(71) Applicant: Taylor Associates/Communications, Inc., Winooski, VT (US)

(72) Inventors: S. Mark Taylor, Charlotte, VT (US); Alexandra N. Spichtig, Essex Junction, VT (US); Ralph Radach, Carrabelle, FL (US)

(21) Appl. No.: 14/810,835

(22) Filed: Jul. 28, 2015

Related U.S. Application Data
(60) Provisional application No. 62/029,891, filed on Jul. 28, 2014.

(51) Int. Cl. G09B 17/02; G09B 17/04

(52) U.S. Cl. CPC G09B 17/02; G09B 17/04

(57) ABSTRACT

A computer-based reading-fluency training tool for helping a reader increase her/his reading speed and comprehension. In some embodiments, the training tool includes a reading frame that displays multiple lines of multiline reading material. The displayed multiple lines are masked, and the training tool moves a guided window through the multiple lines in a controlled manner to temporarily unmask a portion of the multiple lines to guide the reader through the reading material. The multiline reading material can be text-based material for reading-comprehension sessions. The multiline material can be symbol-based material for visual-perception training

### RELATED APPLICATION DATA

This application claims the benefit of priority of U.S. Provisional Patent Application Ser. No. 62/029,891, filed on Jul. 28, 2014, and titled “Guided Window Tool For Improving Reading Skills,” which is incorporated by reference herein in its entirety.

### FIELD OF THE INVENTION

The present invention generally relates to the field of reading fluency training tools. In particular, the present invention is directed to methods and software for providing a guided window tool for improving reading skills.

### BACKGROUND

The ability to read fluently, i.e., effortlessly and with good comprehension, is an important goal within a reading curriculum. Although reading as a school exercise has a long-standing tradition, instructional approaches to achieving fluency goals have varied substantially over the years. In addition, certain components of skilled reading (e.g., fluency and engagement) are often neglected in reading research and subsequently in the classroom. This is unfortunate. If a reader reads text in a laborious and inefficient manner, she/he will have difficulty remembering what has been read and difficulty relating the ideas expressed in the text to her or his background knowledge. While lack of reader engagement is often observed during reading time in classrooms, very little attention is given toward in-depth investigations of underlying causes.

Recent developments in curricular frameworks (e.g., in the form of the Common Core State Standards) further highlight an underlying assumption that readers already are able to read efficiently and propose that instruction focus solely on comprehension and critical reading. The absence of reader reading efficiency, which is a pervasive problem in the United States, prevents or impedes the development of critical reading skills and greatly diminishes readers' ability to understand texts. When reading efficiency is absent or lacking, laborious word decoding is time consuming. In addition, information in short-term memory may begin to decay before it can be processed and assimilated into existing knowledge structures (schemata) where it becomes a stable part of a reader's knowledgebase. Fluent (or efficient) readers are able to read rapidly and without conscious effort, effectively freeing cognitive capacity for information processing and meaning construction.

Although emphasis on silent reading efficiency development has fluctuated over the years, research literature has shown the effectiveness of silent reading training techniques for decades. Earlier methods required teachers to alter instructional features, make individual adaptations in the manner of delivery of training experiences, and manually assign rereading and practice reading. The historical work conducted by Taylor Associates/Communications, Inc., Winooski, Va., in conjunction with its READING PLUS® software stresses the need for fluency in silent reading development.

The latest version of silent reading training in the READING PLUS® software provides automatic changes in formats of lessons, alterations in the rates at which these lessons are presented, and contains a provision whereby reader accomplishment completely automates the training process. This latest version has involved a scrutiny of the data records of more than 500,000 readers, literature in the fields of reading education, psychology, and eye-movement research, and the solicited expert advice of seasoned scholars in the field of reading research.

### SUMMARY OF THE DISCLOSURE

In one implementation, the present disclosure is directed to a method of automatically providing reading fluency training to a reader having a reading rate and a reading efficiency. The method includes presenting multiple lines of multiline reading material as a column within a reading frame on an electronic display, wherein the multiline reading material has a reading direction and the column has a column width; masking the multiple lines of the multiline reading material so as to provide masked reading material; and moving a guided window through the multiline reading material so as to controllably reveal portions of the masked reading material so as to guide the reader across lines of the reading material at a predetermined speed to develop the reading rate and the reading efficiency of the reader, wherein the guided window has: a length; a height that reveals only a single line of the column; a leading end that moves through the multiline reading material in the reading direction at a leading-end speed; and a trailing end that is spaced from the leading end to define the length of the guided window, the trailing end moving line by line through the multiline reading material in the reading direction at a trailing-end speed.

In another implementation, the present disclosure is directed to a machine-readable storage medium containing machine-executable instructions for performing a method of automatically providing reading fluency training to a reader having a reading rate and a reading efficiency. The method includes presenting multiple lines of multiline reading material as a column within a reading frame on an electronic display, wherein the multiline reading material has a reading direction and the column has a column width; masking the multiple lines of the multiline reading material so as to provide masked reading material; and moving a guided window through the multiline reading material so as to controllably reveal portions of the masked reading material so as to guide the reader across lines of the reading material at a predetermined speed to develop the reading rate and the reading efficiency of the reader, wherein the guided window has: a length; a height that reveals only a single line of the column; a leading end that moves through the multiline reading material in the reading direction at a leading-end speed; and a trailing end that is spaced from the leading end to define the length of the guided window, the trailing end moving line by line through the multiline reading material in the reading direction at a trailing-end speed.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is partial schematic diagram/partial simulated screenshot illustrating a reading-fluency training tool made in accordance with the present invention;

FIG. 2A is a simulated screenshot of a screen of an electronic display displaying the reading frame of the reading-fluency training tool of FIG. 1, wherein the reading frame contains multiple lines of multiline reading material, showing the multiple lines without masking present;

FIG. 2B is a simulated screenshot of the screen of FIG. 2A, illustrating the multiple lines of the multiline reading material masked with a mask;

FIG. 2C is a simulated screenshot of the screen of FIG. 2B, illustrating a guided window applied to the multiline reading material within the reading frame;

FIG. 2D is a simulated screenshot of the screen of FIG. 2B, illustrating the guided window progressing from one line of the multiple lines of the multiline reading material to the next line;

FIG. 3 is a screenshot of a guided-window-based reading frame containing text-type multiline reading material;

FIG. 4 is a screenshot of a guided-window-based reading frame containing Landolt-symbol-type multiline reading material;

FIG. 5 is a flow diagram illustrating an exemplary method of adjusting transparency of a mask applied to a reading frame of a reading-fluency training tool;

FIG. 6 is a flow diagram illustrating an exemplary method of adjusting brightness of a mask applied to a reading frame of a reading-fluency training tool;

FIG. 7 is a flow diagram illustrating an exemplary method of adjusting blur of a mask applied to a reading frame of a reading-fluency training tool;

FIG. 8 is a flow diagram illustrating an exemplary method of adjusting speed of the leading end of a guided window of a reading frame of a reading-fluency training tool;

FIG. 9 is a flow diagram illustrating an exemplary method of adjusting length of a guided window of a reading frame of a reading-fluency training tool;

FIG. 10 is a flow diagram illustrating an exemplary method of adjusting font size of reading material presented at least in a guided window of a reading frame of a reading-fluency training tool;

FIG. 11 is a flow diagram illustrating an exemplary overall method for presenting a guided window tool to a reading frame;

FIG. 12 is a flow diagram illustrating an exemplary method for implementing visual-perception training using Landolt symbols; and

FIG. 13 is a diagrammatic representation of a computing system that can be used to implement any one or more of the methodologies and/or tools disclosed herein.

### DETAILED DESCRIPTION

In some aspects, the present disclosure is directed to providing a computer-based reading-fluency training tool for providing reading skill training that allows a reader to increase her/his reading fluency and comprehension. At a high level, such a reading-fluency training tool includes a “guided window” that the training tool automatically and controllably moves “over” multiple lines of otherwise masked or obscured multiline reading material to guide the reader through the reading material. Over the course of a training program, the guided window guides the reader across lines of the reading material at a variety of speeds to develop the reader's reading rate and efficiency with silent reading. In some embodiments, a reading-proficiency training tool of the present disclosure can be configured to provide a computer-based method of developing increased efficiency and capacity in silent reading using increasingly complex text-based reading materials by automatically providing varied reading fluency training formats involving modifications of text display by masking multiple lines of text and revealing only a portion of a line of text within a guided window that moves across each line of text in a smooth and continuous manner.

As described below in detail, such a reading-proficiency training tool can be configured to control any one or more of various characteristics of the guided window and/or of the “underlying” reading material based on one or more parameters, such as one or more parameters for the guided window, one or more parameters for the multiline reading material, and one or more parameters associated with the reader. A number of features and aspects will be understood from reading this entire disclosure. For example, those skilled in the art will learn from reading this entire disclosure that the reading material can be text (e.g., words and paragraphs), non-text strings (e.g., strings of Ladolt symbols and/or other symbols), or any combination of these, depending on the nature of the training

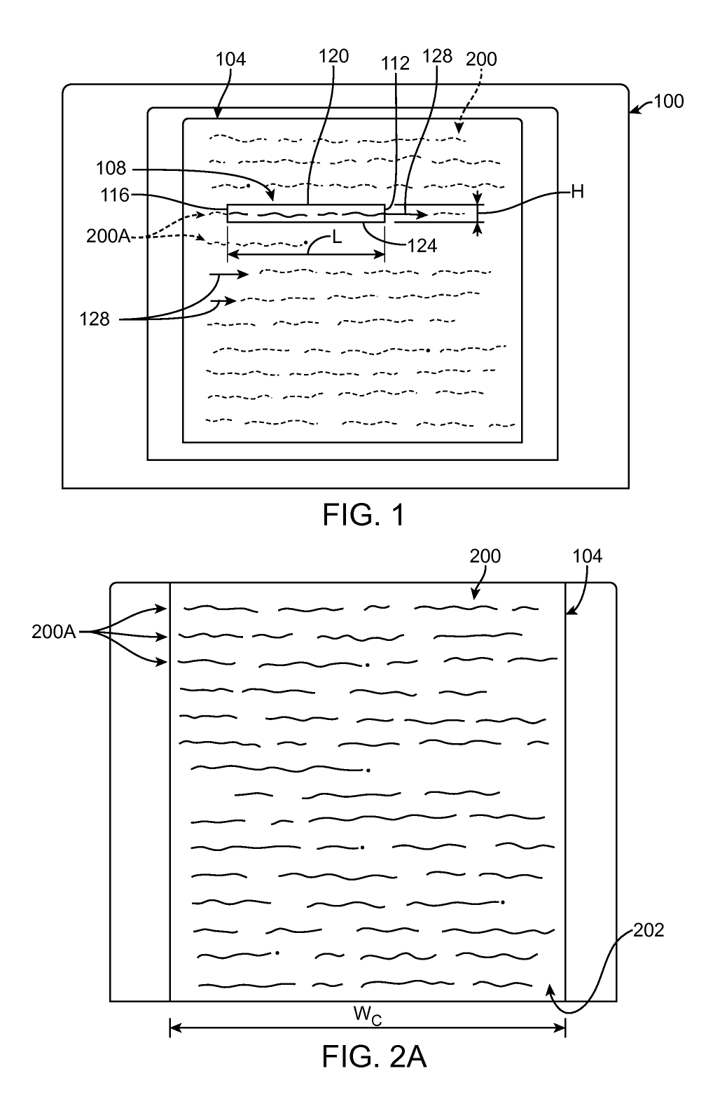

In some embodiments, a reading-proficiency training tool, such as reading-proficiency training tool 100 of FIG. 1 (described in detail below), can be designed and configured to automatically assign a reader to reading efficiency and capacity development lessons in a self-directed, teacher-independent manner in which the lesson formats are varied according to reader accomplishment and learning needs. For example, in some embodiments, a reading-proficiency training tool of the present invention can provide as a first step a unique manner of assessing the current reading proficiency of a reader, as well as his or her attitude toward reading. This first step guides the reading-proficiency tool to assign the most appropriate instructional modules and places a reader in the proper level of instructional content in relation to both the reading complexity level of the content and the reading rate at which the content can be most easily understood.

Following initial establishment of a proper rate-track increment (e.g., rate-calibration lessons), the reading-proficiency training tool may provide the reader with a series of multi-segment reading lessons presented in a timed (rate-track determined), left-to-right, top to bottom guided manner to commence development of fluency in silent reading. The guided left-to-right manner of delivery via a guided window encourages improvement in the subliminal visual/functional left-to-right tracking skills required when reading standard text-based material, as well as improvement in perceptual accuracy skills, which typically operate in a subliminal manner (three to five times per second) and cannot be controlled by a teacher or the reader. Further, this more rapid and sequential input of information into short-term memory consequently provides better potential for retention and comprehension.

As described below in detail, text, or other reading material, outside the guided window can be blurred to make letters (and/or other typographical symbols) and words (or other character strings) illegible while maintaining the visual discreteness of the word forms. The reading material within the guided window may be displayed to appear clear, effectively making the guided window a “corrective lens” that brings the reading material it passes over into sharp focus. This guided presentation of reading material aims to model a reader's perceptual span. (Perceptual span refers to the region around a fixation point (eye stop) from which a reader extracts information). The perceptual span of efficient readers of English-language text usually extends about eight to twelve character spaces to the right, and three to five character spaces to the left, of a fixation point. Text that falls outside of this range cannot be perceived crisply during reading, instead appearing blurred. While readers may not extract cognitive information from this blurred text, word shapes and spacing information are used for spatial orientation and navigation across lines of print. Aspects of the current invention aim to assist readers in developing efficient silent reading habits within a structured practice environment that models efficient reading behavior.

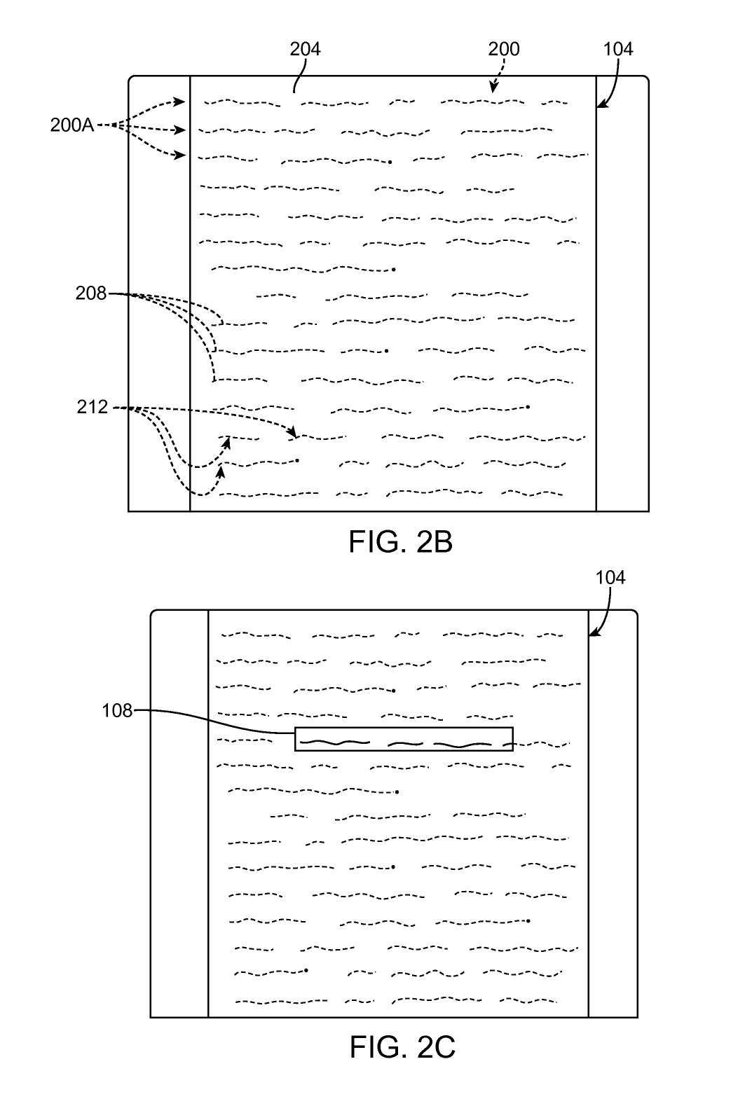

As described above, an important feature of a reading-fluency training tool of the present disclosure is a reading frame having a “guided window” that moves through the reading frame so as to guide a reader through the reading material in a deliberate, predetermined manner based on, for example, the type of training being performed and/or one or more characteristics of the reader, such as age and one or more fluency performance metrics. FIGS. 1 and 2A-2E illustrate a prototypical reading-fluency training tool 100 that includes a reading frame 104 and a corresponding guided window 108 that the reading-fluency training tool controllably moves through the reading frame in a manner described in greater detail below. Before addressing such details, basic features of reading frame 104 and guided window 108 are first described.

Referring to FIG. 2A, this figure illustrates reading frame 104 and its relationship to multiline reading material 200, multiple lines 200A (only a few labeled to avoid clutter) of which are presented in columnar form within the reading frame. Multiline reading material 200 may completely fill reading frame 104 as shown, and may have more lines (also as shown) than the reading frame can display, or it can only partially fill the reading frame. As those skilled in the art will appreciate, FIG. 2A is only a diagrammatic representation of multiline reading material 200 provided to relate the size of the multiline reading material to the size of reading frame 104 as presented to a reader (not shown). In an actual instantiation, multiple lines 200A of multiline reading material 200 will be presented in accordance with graphical display conventions for electronic displays.

As noted above, multiline reading material 200 can be any sort of reading material, such as text-based reading material (e.g., a paragraph in any target language, such as English, Spanish, German, French, etc.) or character-based reading material (e.g., strings of Landolt symbols, among others). In the example shown, multiple lines 200A of multiline reading material 200 are left justified, thereby having a ragged right edge 202 that is dependent on the lengths of the words in each line. In this case, multiple lines 200A have a maximum column width We equal to the length of the longest line in multiline reading material 200, which may or may not be currently displayed within reading frame 104. In other embodiments, multiple lines 200A of multiline reading material 200 may have another type of justification, such as full justification or right justification, among others, with the (maximum) column width varying accordingly.

FIG. 2B illustrates the same reading frame 104 and multiple lines 200A of FIG. 2A, but with a mask 204 applied to visually obscure (e.g., blur) the multiple lines to the reader. In FIG. 2B, this obscuring is represented by the dashed nature of the lines 208 (only a few labeled for convenience) representing words or other strings 212 (only a few labeled for convenience) of typographical symbols (not illustrated). This broken line representation is intended to illustrate that mask 204 may be considered to be analogous to a physical overlay applied over multiple lines 200A. Of course, actual graphical display conventions may not necessarily mimic this physical construct, but may be considered to have the same effect. However, the physical analogy simplifies the description of mask 204 and its effects on the “underlying” multiple lines 200A of multiline reading material 200. Examples of characteristics of mask 204 are described below in detail.

With multiple lines 200A of multiline reading material 200 masked as shown in FIG. 2B, in one analogy guided window 108 (FIG. 1) may be considered to be a moving window through mask 204 so as to clearly reveal to the reader the portions of multiple lines 200A of multiline reading material 200. In embodiments wherein the visual character of mask 204 is to blur multiple lines 200A within reading frame 104, another analogy is that of an optical corrective lens that eliminates the blur so as to present the portion of multiline reading material 200 within guided window 108 clearly as if correcting the blur in the manner of a pair of glasses or contact lenses. Of course, other optical analogies may be suitable depending on the character of mask 204.

FIG. 2C illustrates guided window 108 applied to reading frame 104, and FIG. 1 illustrates the guided window in greater detail. Referring to FIG. 1, guided window 108 may be considered to have a length L, a leading end 112, and a trailing end 116 spaced from the leading end by length L. Guided window 108 is displayed in registration with one or two corresponding lines (two if the guided window is wrapped to a next line) of the underlying multiple lines 200A of multiline reading material 200. Guided window 108 also has a height H that displays a single line of multiple lines 200A. The amount of “whitespace” appearing above and below the typographical symbols (e.g., letters, Landolt symbols, etc.) within guided window 108 may be any desired amount, but it is typical that the upper and lowers edges 120 and 124 are positioned so as to not reveal, respectively, any portion of typographical symbols on the line above the guided window and on the line below the guided window. In some embodiments, the length L of guided window 108 is no longer than 60% of the maximum columnar width Wc of multiline reading material 200, and no less than 10% of the maximum columnar width Wc, or at least five typographical symbols. The software driving guided window 108 can adjust length L of the guided window dynamically based on a reader's performance level (e.g., between 5 typographical symbols to 60% of an average line length), with smaller window sizes for slower developing readers toward larger window sizes for more efficient, advanced readers.

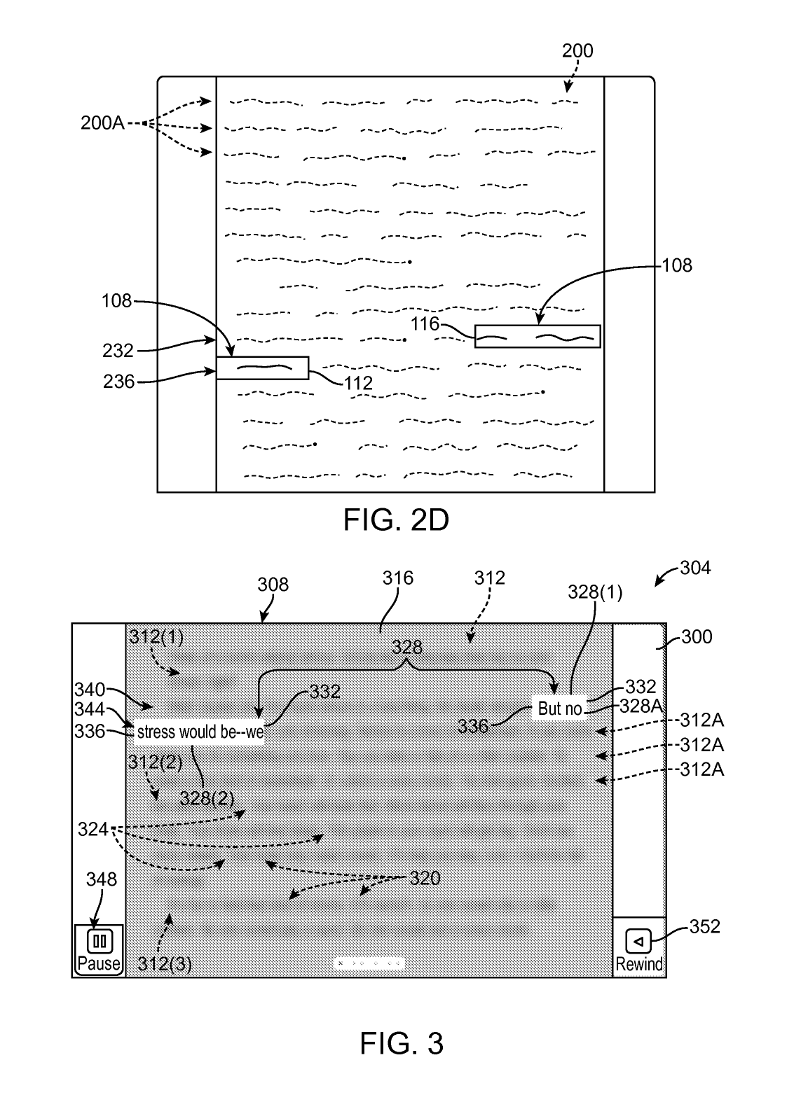

Reading-fluency training tool 100 moves guided window 108 over multiple lines 200A of multiline reading material 200 within reading frame 104 in a highly controlled manner in the reading direction (illustrated by arrows 128), as described in detail below. It is noted, however, that while guided window 108 may be conveniently considered to be moving during a training session, the guided window need not be moved as a unitary unit of fixed length L. Rather, reading-fluency training tool 100 can move each of leading end 112 and trailing end 116 at differing speeds, effectively making length L of guided window 108 variable during its movement across multiple lines 200A of multiline reading material 200. As described below, reading-fluency training tool 100 may set each of the length L of guided window 108 and/or the speeds of leading and trailing ends 112 and 116 as a function of one or more parameters associated with the reader. It is also noted that each of leading and trailing ends 112 and 116 need not be abrupt, or sharp, transitions between the interior of guided window 108, such as shown in FIG. 2C. In other embodiments, such as the embodiment depicted in FIG. 3, the leading and/or trailing end may have graded, or soft, transitions. As an example, if the background of the typographical symbols within the guided window is white (e.g., with black typographical symbols) and the mask is a semitransparent blue mask, one, the other, or both of the leading and trailing ends may be gradually transitioned from white to the semitransparent blue such as by going from a very light shade of blue to the shade of blue of the mask. Such gradient can alternatively or additionally be expressed in one or more other terms, such as level of blur (e.g., illegible blur to sharp) and transparency (e.g., 25% transparency to 100% transparency).

FIG. 2D illustrates guided window 108 at a stop-action instant in time after it has progressed to the end of line 232 and already started revealing the next line 236 of multiple lines 200A of multiline reading material 200. Reading-fluency training tool 100 (FIG. 1) is typically configured so that when moved in realtime for a training session, the movement of leading and trailing ends 112 and 116, and guided window 108 itself, appears smooth and continuous to a reader participating in the training session. Skilled programmers can readily program all of the features described herein using programming techniques known in the field of programming.

As described below, reading-fluency training tool 100 (FIG. 1) can be configured to adjust font size of typographical symbols in multiple lines 200A of multiline reading material 200 displayed in reading frame 104 based on a reader's performance, age, and practice focus (e.g., 24 point font for younger developing readers, 14 point font for advanced adult readers). In some embodiments, the software behind reading-fluency training tool 100 calculates an average speed for guided window 108 for each lesson in terms of the overall lesson content the guided window is expected to cover, the font size of the text, and the reader's current word-per-minute (WPM) reading rate. For example, if a given text-based multiline reading material 200 contains 500 words and a reader's current rate is 250 WPM, then reading-fluency training tool 100 may determine that guided window 108 will have 2 minutes to travel the distance of this text. Reading-fluency training tool 100 calculates this rate into a pixel-by-pixel speed at which it moves guided window 108 through such multiline reading material 200 given a current font size.

The software behind reading-fluency training tool 100 can be designed and configured to recognize actual line lengths of multiple lines 200A displayed in reading frame 104 and dynamically accommodate varied line lengths (i.e. irregular, or ragged, right margins) by launching the opening of guided window 108 on a next line at a given trigger point. For example, when guided window 108 is located entirely on one of multiple lines 200A, reading-fluency training tool 100 may trigger a new segment of the guided window to open on the next line of the multiple lines when leading end 112 of the guided window on the current line reaches 85% of the length of that line. It is noted that reading-fluency training tool 100 may be designed and configured to vary trigger points based on a calculated reading rate and/or font size of the typographical symbols within multiple lines 200A of the multiline reading material displayed in reading frame 104. For example, the opening of a segment of guided window 108 on a next line may be triggered when leading end 112 of the current guided window reaches 85% of length of that line if rate is between 200-250 WPM and length L of the guided window is 25 typographical symbols. Reading-fluency training tool 100 may also be designed and configured to recognize paragraph endings to provide extra content wrap-up and integration times. For example, reading-fluency training tool 100 may provide an extra 200-800 milliseconds when leading end 112 of guided window 108 reaches the end of a paragraph. It is noted that reading-fluency training tool may be designed and configured to vary this time for different age/class versus performance levels. For example, a 12^{th} grade reader reading at a 10^{th} grade reading level may get an extra 500 milliseconds.

In some embodiments, the closing and opening speeds of guided window 108, i.e., the speeds of trailing end 116 and leading end 112, respectively, are intended to model reading habits of fluent readers. In such embodiments, reading-fluency training tool 100 may vary the closing speed of guided window 108 as a function of a reader's reading rate and, consequently, may close the guided window faster with increasing opening speed of the guided window. For example, with guided window 108 opening at a rate of 200 WPM, reading-fluency training tool 100 may close guided window 108 at a rate of 125% of the opening speed). Reading-fluency training tool 100 may vary characteristics (e.g., in terms of time and speed) of opening guided window 108 as a function of font size, guided window width, line lengths, and/or a reader's reading rate. For example and as noted above, the opening of a new segment of guided window 108 on a next line may be triggered when leading end 112 of the guided window on the current line reaches 85% of the length of the current line if the determined reading rate is between 200-250 WPM and the length L of the guided window is 25 typographical symbols. In addition, the speed at which reading-fluency training tool 100 opens a new segment of guided window 108 on a next line may be impacted by a reader's current reading rate. For example, if a reader is reading at 200 WPM, reading-fluency training tool 100 may open the new segment on the next line at 125% of the current reading rate.

FIG. 3 illustrates an actual instantiation of a screen 300 of a reading-fluency training tool 304 made in accordance with the present invention. Screen 300 contains a reading frame 304 located within a structure-reading practice window 308. Reading frame 304 displays multiple lines 312A (only a few labeled to avoid clutter) of multiline reading material 312, here, multiline text composed of multiple paragraphs, such as paragraphs 312(1), 312(2), and 312(3). Multiple lines 312A are presented in left-justified (ragged-right) form, with paragraphs 312(2) and 312(3) having first-line indents and paragraph 312(1) having full indent. Reading frame 304 is masked with a blurring and colored mask 316, with individual words “behind” the mask, such as words 320 (only a few labeled to avoid clutter), blurred to the point of the reader not being able to read them but not blurred to the point that the reader cannot delineate the beginnings and ends of the words, which are separated by spaces 324 (only a few labeled to avoid clutter).

Reading frame 304 includes a guided window 328, the movement of which is in the direction of reading and is captured in a single instant in time in FIG. 3. During a training session, the movement of guided window 328, i.e., the movement of leading and trailing ends 332 and 336 of the guided window, is smooth and continuous. As shown, guided window 328 is wrapped from one line 340 to the next line 344 as it fully transitions between the two. In this example, each of leading and trailing ends 332 and 336 have a gradient applied between mask 316 and the interior 328A of guided window 328. Because of the nature of guided window 328 and its transition from line to line, here line 340 to line 344, during such transition the guided window appears in two separate segments 328(1) and 328(2), but the segments are considered to make up the whole guided window. In the embodiment shown, each segment 328(1), 328(2) has its own leading and trailing ends 332 and 336, each of which correspond to the respective leading and trailing end of guiding window 328 when the entire guiding window is on one line (not shown).

In this example, structure-reading practice window 308 also contains a pause button 348, which may be provided in effort to ensure comprehension is never compromised during a reading portion of a lesson due to distraction or other interruptions. Pause button 348 may allow a reader to stop movement of guided window 328 while maintaining the position of the guided window within reading frame 304. Whenever a reader selects pause button 348, the software providing reading-fluency training tool 304 may mask all text inside reading frame 304 for the duration of the pause. In this example, structure-reading practice window 308 further contains a rewind button 352 that allows the reader to back up the location of guided window 328, for example, to the beginning of the previously presented sentence or a small number of words, among other distances.

### Exemplary Reading-Fluency Training Tool Functionality

As described above, aspects of a reading-fluency training tool of the present invention, such as reading-fluency training tool 100, provide structured reading practice that varies in the manner of presentation and the rates at which practice material is delivered. Such a reading-fluency training tool may be designed and configured to allow each reader to commence fluency development by providing various combinations of independent and guided reading practice involving various combinations of segmented reading lessons (i.e. any combinations of one to many reading material segments). The reading-fluency training tool may appropriately gauge a reader's starting practice rates during an initial set of lessons that the training tool provides. The reading-fluency training tool may vary the number of required rate calibration lessons based on a reader's performance consistency as determined by the training tool. The reading-fluency training tool may conclude each lesson with a thorough comprehension check involving a mix of core, craft, and critical reading questions that assess a reader's deep understanding of a text.

Additional or alternative aspects of a reading-fluency training tool of the present invention, such as reading-fluency training tool 100, may provide visual perceptual training to support development of a reader's visual perceptual skills, including coordinated left-to-right navigation ability, visual discrimination, visual memory, instant recognition skills, and visual span. In some embodiments the reading-fluency training tool may include an additional activity for such training, namely, the “Scan” training described below. In some embodiments, the reading-fluency training tool is designed and configured to automatically assign readers to structured reading practice if their silent reading rate is below a certain threshold (e.g., 140 words per minute), as measured during visual perceptual training assessment.

During Scan training, the reading-fluency training tool may use symbol strings instead of words (e.g. strings of rings and open rings (such as Landolt rings and Landolt open rings) or squares and triangles, among others). A goal of this activity is to remove the cognitive processing demands needed to decode actual words while closely approximating a wide range of non-linguistic processing demands typical for reading. This type of training is meaningful because it mimics a reading-like experience as the typographical symbols are combined into word-like strings and it provides a training environment wherein the stress of linguistic processing is removed while many other reading-relevant skills are systematically reinforced, thus building automaticity.

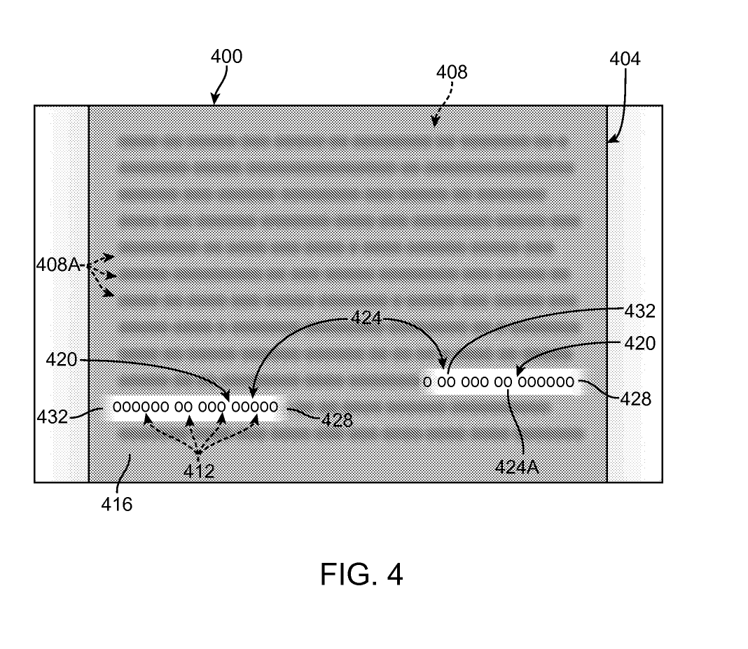

FIG. 4 illustrates an exemplary implementation of a visual-perception training window 400 for providing visual-perception training using non-word strings of typographical symbols, in this case Landolt rings and open rings. In this example, visual-perception training window 400 contains a reading frame 404 that displays multiple lines 408A of multiline reading material 408, here, multiline symbol-based strings 412 (only a few labeled to avoid clutter) composed of Landolt rings and Landolt open rings. Multiple lines 408A are presented in left-justified (ragged-right) form, though other justification(s) may be used. Reading frame 404 is masked with a blurring and colored mask 416, with individual strings 412 “behind” the mask blurred to the point of the reader not being able to read them but not blurred to the point that the reader cannot delineate the beginnings and ends of the strings, which are separated by spaces 420 (only a few labeled to avoid clutter).

Reading frame 404 includes a guided window 424, the movement of which is in the direction of reading and is captured in a single instant in time in FIG. 4. During a training session, the movement of guided window 424, i.e., the movement of leading and trailing ends 428 and 432 of the guided window, is smooth and continuous. In this example, each of leading and trailing ends 428 and 432 have a gradient applied between mask 416 and the interior 424A of guided window 424. Wrapping of guided widow 424 may be the same as or similar to the wrapping of guided window 328 described above in connection with FIG. 3.

In an exemplary embodiment, the reading-fluency training tool embodying visual-perception training window 400 of FIG. 4 may be designed and configured to move guided window 424 through multiple lines 408A of multiline reading material 408 and record a reader's indication that they see an incomplete string of the practice typographical symbols. For example, if Landolt rings and open rings are used, a string would be incomplete if it contained an open ring (e.g. oocoo) or vice versa (e.g. ccocc). The targets that are responsible for breaking the completeness of strings are located at ideal fixation positions, thus encouraging beneficial reading-like behavior that match the behaviors of efficient advanced adult readers. The reading-fluency training tool may provide average string lengths that vary as a function of a reader's performance level (e.g., from 2 typographical symbols to 10 typographical symbols), and the training tool may also dynamically adjust the speed of the guided window (e.g., up or down from 2 WPM to 20 WPM) based on the current reader's performance characteristics. In one example, the reading-fluency training tool may receive such user indication when the reader presses on the space bar of a common hardware computer keyboard (not shown) every time they see an incomplete string of the practice typographical symbols. Of course, those skilled in the art will readily understand that virtually any computer recognizable indication from the reader may be used to trigger the reading-fluency training tool to record the reader's seeing of an incomplete string. Examples of other reader indications include, but are not limited to, “clicking” of a computer mouse button, tapping of a touchscreen, speaking of a keyword or keyphrase, such as “incomplete,” among many others.

### Exemplary Functionality Logic

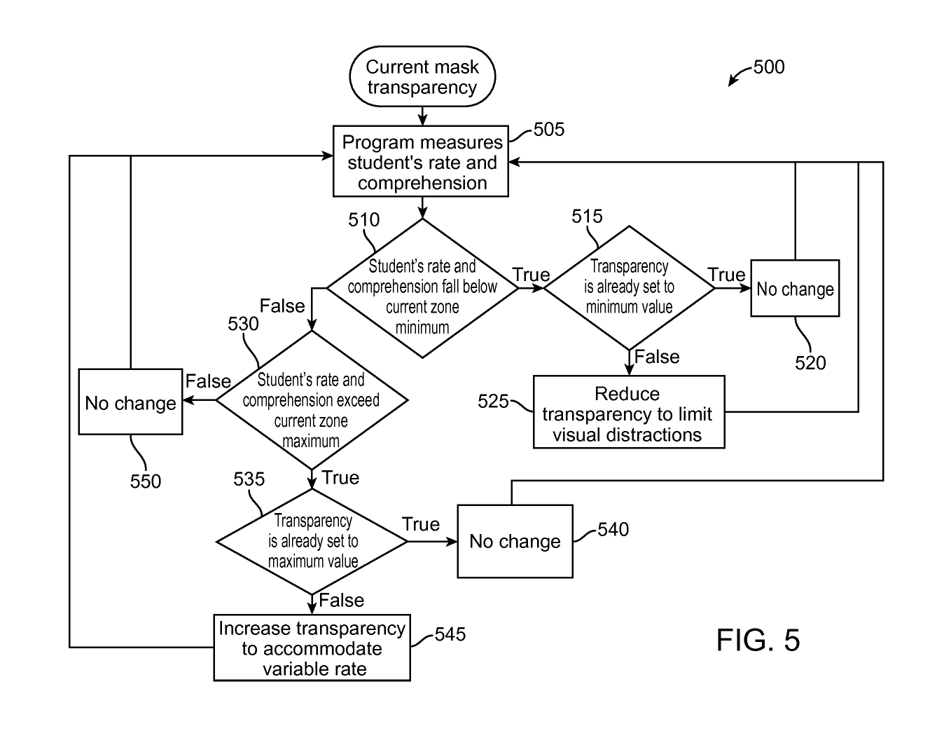

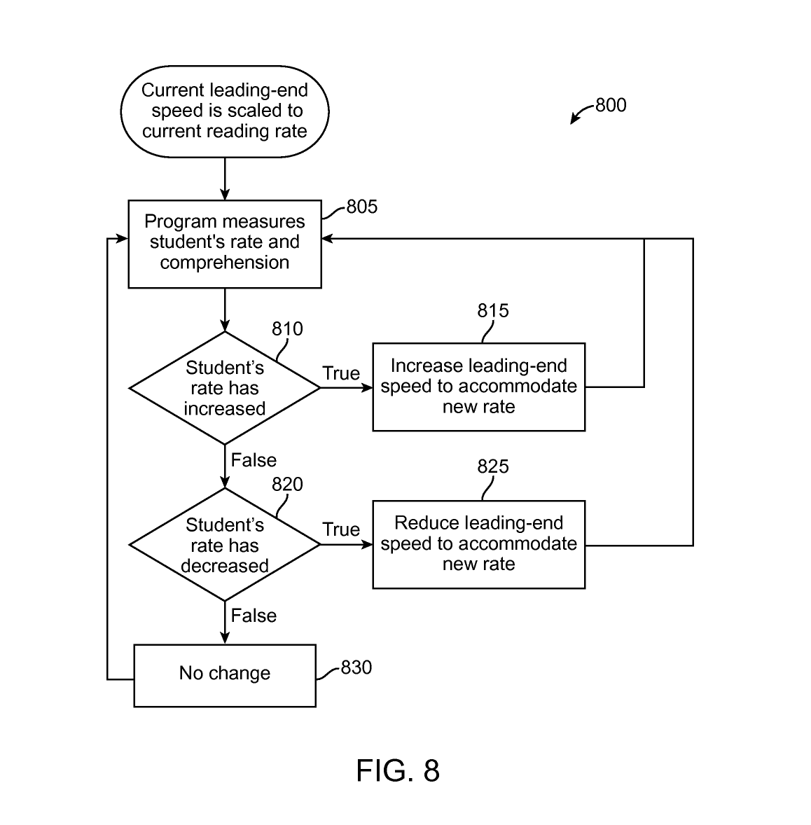

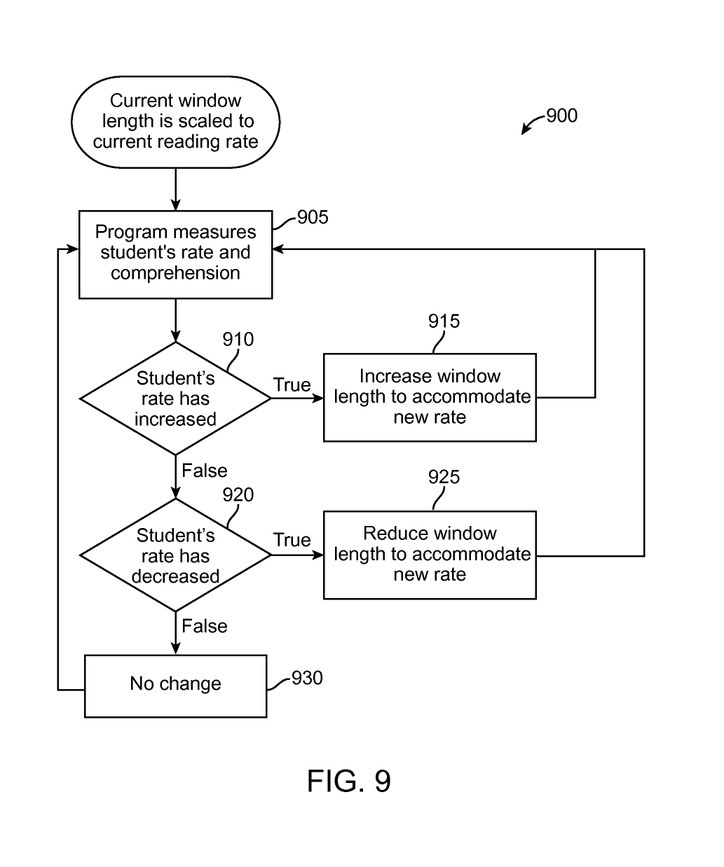

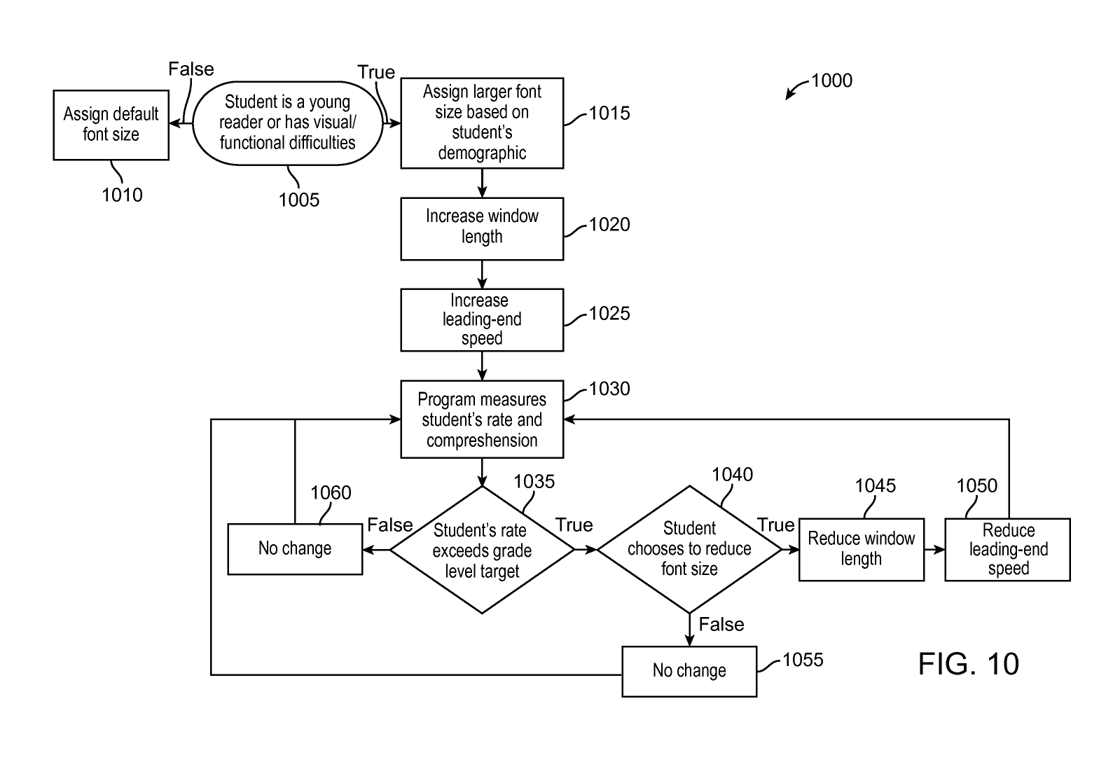

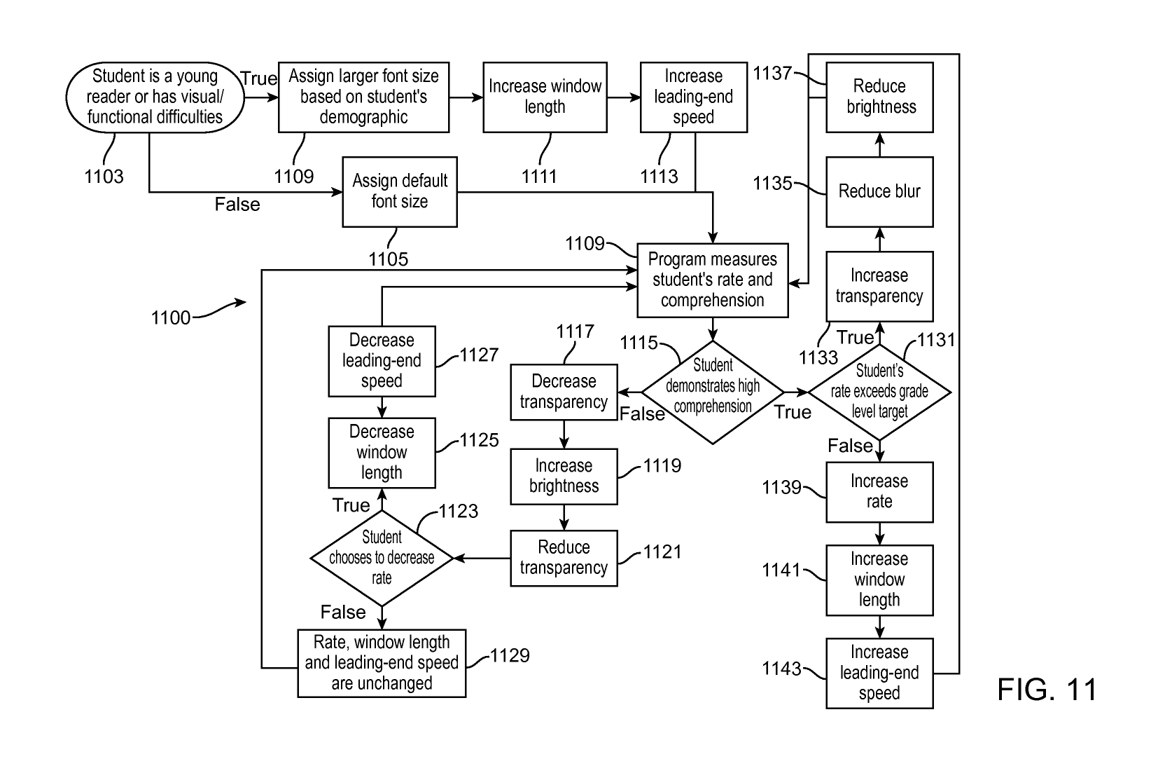

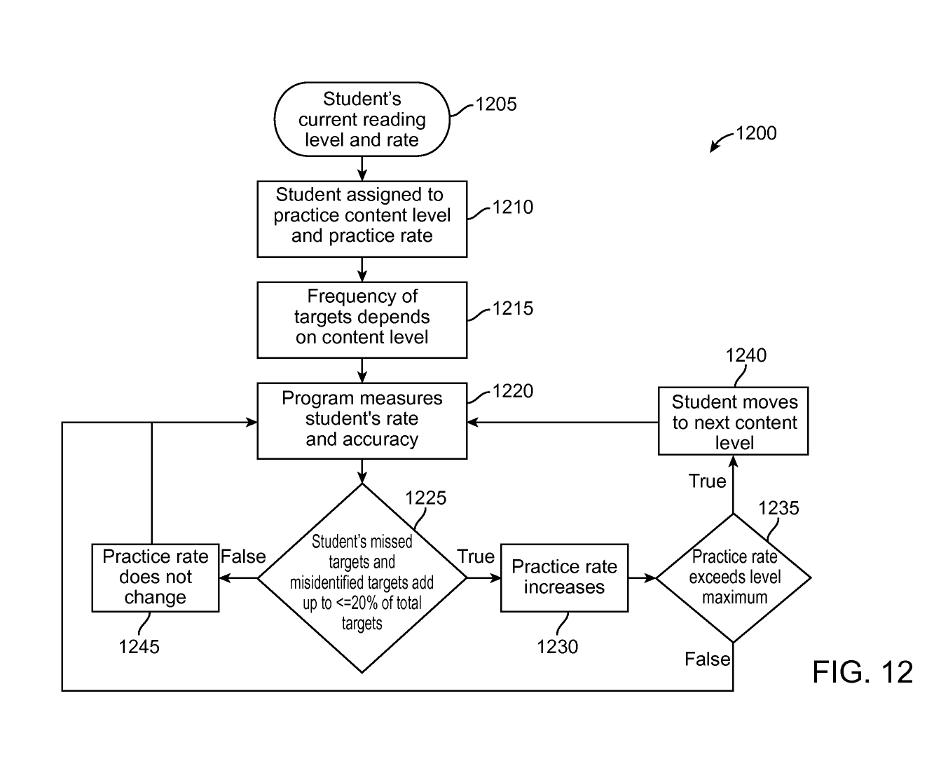

With some generalities and exemplary functionality of a reading-fluency training tool of the present disclosure presented above along with some examples of various components of such a tool, following are examples of how such a tool can be implemented in suitable training tool software. FIGS. 5 through 7 illustrate exemplary methods 500, 600, and 700, respectively, of varying characteristics of a mask within a reading frame of a reading-fluency training tool made in accordance with the present invention, such as any one of masks 204, 316, and 416 of FIGS. 2B, 3, and 4, respectively. For this embodiment, the subject mask has a transparency, brightness, and blur, and methods 500, 600, and 700, respectively, control these characteristics as a function of a reader's, or “student's”, reading rate and comprehension as determined by appropriate reading rate and comprehension assessment logic within the reading-fluency training tool. FIG. 8 is directed to an exemplary method 800 of scaling the speed of the leading end of a guided window within a reading frame based on a student's reading rate [and comprehension], again as determined by appropriate reading rate and comprehension assessment logic within the reading-fluency training tool. Similarly, FIG. 9 illustrates an exemplary method 900 of scaling the length of a guided window within a reading frame based on a student's reading rate [and comprehension] as determined by appropriate reading rate and comprehension assessment logic within the reading-fluency training tool. FIG. 10 illustrates an exemplary method 1000 of controlling font size of the portion of multiline reading material displayed in a reading frame based on characteristics of a reader/student, here age and visual/functional difficulties. FIG. 11 is directed to an exemplary unified logic 1100 that can be used to control main functionality of a reading frame and corresponding guided window. FIG. 12 illustrates a method 1200 for implementing visual-perception training, such as the Landolt symbol based visual-perception training described above in connection with FIG. 4.

Referring now to FIG. 5, as noted above, this figure illustrates an exemplary method 500 of varying transparency of a mask within a reading frame of a reading-fluency training tool made in accordance with the present invention, such as any one of masks 204, 316, and 416 of FIGS. 2B, 3, and 4, respectively. As can be readily seen from FIG. 5, at step 505 the “Program”, i.e., the computer code executing reading-fluency training tool functionality, measures a reader's, or student's, reading rate and comprehension. At step 510, the computer program assesses whether or not the student's reading rate and comprehension fall below a minimum level for the current practice zone. If so, the computer program assesses at step 515 whether or not the transparency of the mask is already set to its minimum value. If so, at block 520, the computer program does not make any change to the mask's transparency and method 500 loops back to step 505 to continue measuring the student's reading rate and comprehension. However, if the computer program determines at step 515 that the transparency is not already set to its minimum value, at step 525 the computer program reduces transparency to limit visual distractions to the student.

If at step 510 the computer program determines that the student's reading rate and comprehension do not fall below the current practice zone minimum, at step 530 the computer program determines whether or not the student's reading rate and comprehension exceed a maximum level for the current practice zone. If so, the computer program assesses at step 535 whether or not the transparency of the mask is already set to its maximum value. If so, at block 540, the computer program does not make any change to the mask's transparency and method 500 loops back to step 505 to continue measuring the student's reading rate and comprehension. However, if the computer program determines at step 535 that the transparency is not already set to its maximum value, at step 545 the computer program increases transparency to accommodate variable reading rate, and method 500 loops back to step 505 to continue measuring the student's reading rate and comprehension. If at step 530 the computer program determines that the student's reading rate and comprehension exceed the current practice zone maximum, at block 550 the computer program does not make any change to the mask's transparency, and method 500 loops back to step 505 to continue measuring the student's reading rate and comprehension.

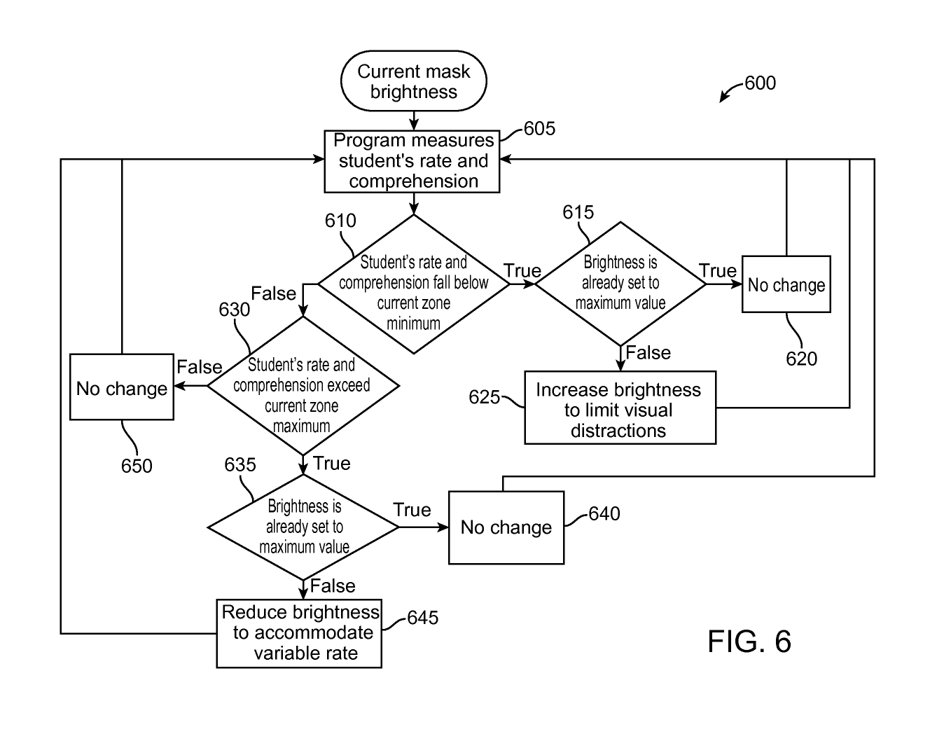

As noted above, FIG. 6 illustrates an exemplary method 600 of varying brightness of a mask within a reading frame of a reading-fluency training tool made in accordance with the present invention, such as any one of masks 204, 316, and 416 of FIGS. 2B, 3, and 4, respectively. As can be readily seen from FIG. 6, at step 605 the computer program measures a reader's, or student's, reading rate and comprehension. At step 610, the computer program assesses whether or not the student's reading rate and comprehension fall below a minimum level for the current practice zone. If so, the computer program assesses at step 615 whether or not the brightness of the mask is already set to its maximum value. If so, at block 620, the computer program does not make any change to the mask's brightness and method 600 loops back to step 605 to continue measuring the student's reading rate and comprehension. However, if the computer program determines at step 615 that the brightness is not already set to its maximum value, at step 625 the computer program increases mask brightness to limit visual distractions to the student.

If at step 610 the computer program determines that the student's reading rate and comprehension do not fall below the current practice zone minimum, at step 630 the computer program determines whether or not the student's reading rate and comprehension exceed a maximum level for the current practice zone. If so, the computer program assesses at step 635 whether or not the brightness of the mask is already set to its minimum value. If so, at block 640, the computer program does not make any change to the mask's brightness and method 600 loops back to step 605 to continue measuring the student's reading rate and comprehension. However, if the computer program determines at step 635 that the brightness is not already set to its minimum value, at step 645 the computer program increases the mask's brightness to accommodate variable reading rate, and method 600 loops back to step 605 to continue measuring the student's reading rate and comprehension. If at step 630 the computer program determines that the student's reading rate and comprehension exceed the current practice zone maximum, at block 650 the computer program does not make any change to the mask's brightness, and method 600 loops back to step 605 to continue measuring the student's reading rate and comprehension.

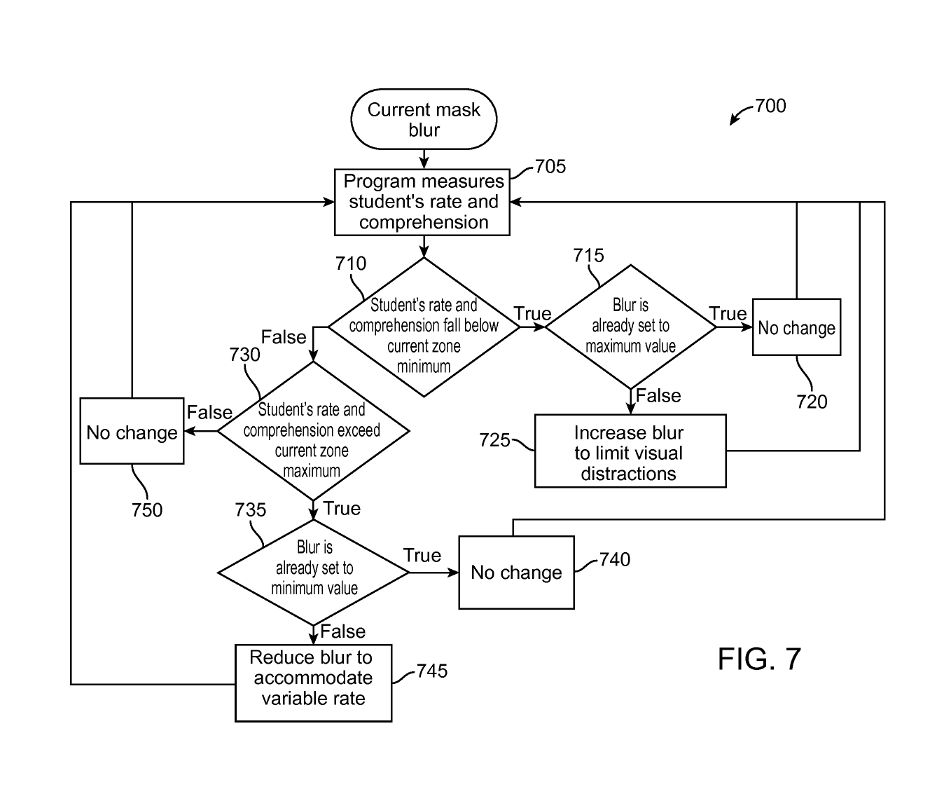

As noted above, FIG. 7 illustrates an exemplary method 700 of varying blur of a mask within a reading frame of a reading-fluency training tool made in accordance with the present invention, such as any one of masks 204, 316, and 416 of FIGS. 2B, 3, and 4, respectively. As can be readily seen from FIG. 7, at step 705 the computer program measures a reader's, or student's, reading rate and comprehension. At step 710, the computer program assesses whether or not the student's reading rate and comprehension fall below a minimum level for the current practice zone. If so, the computer program assesses at step 715 whether or not the blur of the mask is already set to its maximum value. If so, at block 720, the computer program does not make any change to the mask's blur and method 700 loops back to step 705 to continue measuring the student's reading rate and comprehension. However, if the computer program determines at step 715 that the blur is not already set to its maximum value, at step 725 the computer program increases mask blur to limit visual distractions to the student.

If at step 710 the computer program determines that the student's reading rate and comprehension do not fall below the current practice zone minimum, at step 730 the computer program determines whether or not the student's reading rate and comprehension exceed a maximum level for the current practice zone. If so, the computer program assesses at step 735 whether or not the blur of the mask is already set to its minimum value. If so, at block 740, the computer program does not make any change to the mask's blur and method 700 loops back to step 705 to continue measuring the student's reading rate and comprehension. However, if the computer program determines at step 735 that the blur is not already set to its minimum value, at step 745 the computer program increases the mask's blur to accommodate variable reading rate, and method 700 loops back to step 705 to continue measuring the student's reading rate and comprehension. If at step 730 the computer program determines that the student's reading rate and comprehension exceed the current practice zone maximum, at block 750 the computer program does not make any change to the mask's blur, and method 700 loops back to step 705 to continue measuring the student's reading rate and comprehension.

As noted above, FIG. 8 illustrates an exemplary method 800 of scaling the speed of the leading end of a guided window of a reading-fluency training tool made in accordance with the present invention, such as either of leading ends 112 and 332 of FIGS. 1 and 3, respectively. In this example, the speed of the leading end is scaled to a current reading rate and/or comprehension of the student. At step 805, the computer program measures the student's current reading rate, and optionally the student's comprehension, using suitable reading rate and/or comprehension-assessing logic, and compares the current rate to a prior rate. At step 810, if the student's reading rate has increased, at step 815 the computer program increases the speed of the leading end of the guided window to accommodate an increased reading rate, and method 800 loops back to step 805 to continue measuring the student's reading rate and/or comprehension. If step 810 determines that the student's reading rate has not increased, at step 820 the computer program determines whether or not the student's reading rate has decreased. If step 820 determines that the student's reading rate has decreased, at step 825 the computer program reduces the speed of the leading end of the guided window to accommodate a slower reading rate, and method 800 loops back to step 805 to continue measuring the student's reading rate and/or comprehension. If step 820 determines that the student's reading rate has not decreased, no speed change is made as indicated at block 830, and method 800 loops back to step 805 to continue measuring the student's reading rate and/or comprehension.

As noted above, FIG. 9 illustrates an exemplary method 900 of scaling the length of a guided window of a reading-fluency training tool made in accordance with the present invention, such as guided window 108, 328, and 424 of FIGS. 1, 3, and 4, respectively. In this example, the length is scaled to a current reading rate and/or comprehension of the student. At step 905, the computer program measures the student's current reading rate, and optionally the student's comprehension, using suitable reading rate and/or comprehension-assessing logic, and compares the current rate to a prior rate. At step 910, if the student's reading rate has increased, at step 915 the computer program increases the length of the guided window to accommodate an increased reading rate, and method 900 loops back to step 905 to continue measuring the student's reading rate and/or comprehension. If step 910 determines that the student's reading rate has not increased, at step 920 the computer program determines whether or not the student's reading rate has decreased. If step 920 determines that the student's reading rate has decreased, at step 925 the computer program reduces the length of the guided window to accommodate a slower reading rate, and method 900 loops back to step 905 to continue measuring the student's reading rate and/or comprehension. If step 920 determines that the student's reading rate has not decreased, no length change is made as indicated at block 930, and method 900 loops back to step 905.

As noted above, FIG. 10 is directed to an exemplary method 1000 of controlling font size of the portion of multiline reading material displayed in a reading frame, such as reading frame 104, 304, and 404 of FIGS. 1, 3, and 4, respectively. In this example, font size is controlled based on characteristics of a reader/student, here age and visual/functional difficulties. At step 1005, it is determined whether or not the student is a young reader and/or has visual and/or functional difficulties. The student's age may be received, for example, via a questionnaire screen presented to the student, provided by a training professional, or input into the computer program in any suitable manner. Whether or not the student has visual/functional difficulties may be determined in any one or more of a variety of ways, such as by questionnaire input and/or via automated testing by the computer program, such as via visual-perception training described herein. If step 1005 reveals that the student is not sufficiently young and/or does not have any visual/functional difficulty, at step 1010 the computer program initially uses a default font size. However, if step 1005 reveals that the student is sufficiently young and/or has visual/functional difficulty, at step 1015 the computer program assigns a larger font size for the portion of multiline reading material to be displayed in the reading frame. At optional steps 1020 and 1025, the computer program may, respectively, increase the length of the guided window and increase the speed of the leading end of the guided window to compensate for the larger font size.

At step 1030, the computer program measures the student's reading rate and comprehension, for example, using built-in reading rate and comprehension measurement logic. At step 1035, the computer program determines whether or not the student's reading rate exceeds an established grade-level target reading-rate value. If so, at step 1040 the computer program determines whether or not the student has chosen to reduce font size. As an example, the determination at step 1040 may be based on the computer program prompting the student to provide an indication of whether or not she/he wants to reduce the font size. If at step 1040 the computer program determines that the student desires it to reduce the font size, method 1000 proceeds to steps 1045 and 1050 at which the computer program, respectively, reduces the length of the guided window and reduces the speed of the leading end of the guided window to compensate for the smaller font size. After step 1050, method 1000 loops back to step 1030 to continue measuring the student's reading rate and comprehension. If the computer program determines at step 1040 that the student does not want to reduce font size, no size change is made at block 1055, and method 1000 loops back to step 1030 to continue measuring the student's reading rate and comprehension. If at step 1035 the program determines that the student's reading rate does not exceed the established grade-level target reading-rate value, no size change is made at block 1060, and method 1000 loops back to step 1030 to continue measuring the student's reading rate and comprehension.

As noted above, FIG. 11 illustrates exemplary unified logic 1100 that can be implemented to control important functionality of the reading-fluency training tool at issue. As will be seen, unified logic 1100 agglomerates faces of methods 500, 600, 700, 800, 900, and 1000 described above in connection with FIGS. 5 through 10, respectively. Referring now to FIG. 11, at step 1103 it is determined whether or not the student is a young reader and/or has visual and/or functional difficulties. The student's age may be received, for example, via a questionnaire screen presented to the student, provided by a training professional, or input into the computer program in any suitable manner. Whether or not the student has visual/functional difficulties may be determined in any one or more of a variety of ways, such as by questionnaire input and/or via automated testing by the computer program, such as via visual-perception training described herein. If step 1103 reveals that the student is not sufficiently young and/or does not have any visual/functional difficulty, at step 1105 the computer program initially uses a default font size, and method 1100 proceeds to step 1107 at which the computer program measures the student's reading rate and comprehension, for example, in the manner described above relative to method 500 of FIG. 5. However, if step 1103 reveals that the student is sufficiently young and/or has visual/functional difficulty, at step 1109 the computer program assigns a larger font size for the portion of multiline reading material to be displayed in the reading frame. At optional steps 1111 and 1113, the computer program may, respectively, increase the length of the guided window and increase the speed of the leading end of the guided window to compensate for the larger font size before proceeding to step 1107.

After measuring the student's reading rate and comprehension at step 1107, the computer program may determine whether or not the student demonstrates high comprehension at step 1115. The computer program may make this determination, for example, by comparing a measured comprehension value to a target grade-level value. If the measured value is not greater than the target value at step 1115, then unified logic 1100 may proceed to steps 1117, 1119, and 1121 at which the computer program modifies the mask applied to the reading frame by, respectively, decreasing transparency, increasing brightness, and increasing blur.

After modifying the mask, unified logic 1100 may proceed to step 1123 at which the computer program determines whether or not the student has chosen to reduce the reading rate. As an example, the determination at step 1123 may be based on the computer program prompting the student to provide an indication of whether or not she/he wants to reduce the reading rate. If at step 1123 the computer program determines that the student desires it to reduce the reading rate, unified logic 1100 proceeds to steps 1125 and 1127 at which the computer program, respectively, reduces the length of the guided window and reduces the speed of the leading end of the guided window. After step 1127, unified logic 1100 loops back to step 1107 to continue measuring the student's reading rate and comprehension. If the computer program determines at step 1123 that the student does not want to reduce the reading rate, at block 1129 no changes are made to the reading rate, guided window length, and leading-end speed, and unified logic 1100 loops back to step 1107 to continue measuring the student's reading rate and comprehension.

If at step 1115 the measured value is not greater than the target value, then unified logic 1100 may proceed to step 1131 at which the computer program determines whether or not the student's reading rate exceeds a grade-level target attributed to that student. If the computer program determines that the student's reading rate indeed exceeds the grade-level target, unified logic 1100 may proceed to steps 1133, 1135, and 1137 at which the computer program modifies the mask applied to the reading frame by, respectively, increasing transparency, reducing blur, and reducing brightness before proceeding back to reading rate and comprehension measurement step 1107. However, if the computer program determines that the student's reading rate does not exceed the grade-level target, unified logic 1100 may alternatively proceed to steps 1139, 1141, and 1143 at which the computer program, respectively, increases the reading rate, increases the length of the guided window, and increases the speed of the leading end of the guided window before proceeding back to reading rate and comprehension measurement step 1107.

As mentioned above, FIG. 12 illustrates an exemplary method 1200 for implementing visual-perception training, such as the Landolt symbol based visual-perception training described above in connection with FIG. 4. Referring to FIG. 12, at step 1205, the computer program contains the student's current reading level and reading rate. This information may be determined automatically by the reading-fluency training tool using reading-fluency performance data collected by the training tool during one or more prior training sessions or may be obtained in another way, such as being input into a suitable user interface of the computer program, among others. At step 1210, the computer program uses the student's current reading level and reading rate to assign to the student a practice content level and a practice rate. At step 1215, the computer program determines the frequency of the “targets” to be identified by the student based on the practice content level. In this context and as described above relative to FIG. 4, the targets are a symbol or pattern of symbols that are each supposed to trigger the student to provide an indication to the computer program that the student has seen the target.

At step 1220, the computer program receives indications of identified targets from the student and measures the student's identification rate and accuracy. At step 1225, the computer program sums the student's missed targets and misidentified targets and compares that sum to the total number of targets presented. In this example, if the sum is less than or equal to some percentage, for example, 20%, of the total targets, then method 1200 proceeds to step 1230 at which the computer program increases the presentation rate. If the computer program determines at step 1235 that the practice rate exceeds the maximum rate of the current level, then at step 1240 the computer program moves the student to the next content level, and method 1200 loops back to step 1220 to continue receiving target-recognition indications and measuring the student's recognition rate and accuracy. If, however, at step 1235 the computer program determines that the practice rate does not exceed the maximum rate at the current level, then method 1200 loops back to step 1220 and proceeds on the current content level. If back at step 1225 the sum is greater than 20% of the total targets, then at block 1245 the computer program does not change the current presentation rate, and method 1200 loops back to step 1220 to continue receiving target-recognition indications and measuring the student's recognition rate and accuracy.

### Exemplary Technical Implementation

Following is an example of implementing a guided window of the present disclosure in a particular programming environment. Those skilled in the art will readily understand that this example is provided for illustration and not to limit the scope of the present invention in any way.

The multi-line presentation format of this example is an implementation of the Canvas HTML5 element via a web-browser environment. All text and animation is contained within a block-level element with the following outer dimensions: width=786 pixels (px); height=488 px. In this particular example, there is a maximum of 12 lines per screen, the multiline reading material is displayed in a left-justified manner, the font is Arial 20 px with a line-height of 40 px, and each line of the displayed multiline reading material has a 35 px left margin and 25 px right margin.

In this example, the mask provides a blur effect, which is achieved in this example by pre-rendering each screen of text in two forms: 1) a clear text version of the screen of text and 2) a blurred version of the screen of text. Both clear text and blurred versions of each screen are rendered outside the visible area of the browser. The blurred screen context is then rendered to the main stage.

In this particular example, the moving guided window is 288 px wide and 40 px high, with a 28 px gradient on both left and right sides while in motion. The moving guided window is animated using a built-in browser function requestAnimationFrame( ). When animating the moving guided window, the clear text version of the screen is drawn in the area of the window to replace the blurred text, and with each animationFrame request, the moving guided window is redrawn in a new location and the blurred version is redrawn in the location that has been vacated by the clear text. In this way the window appears to move along the line of text.

Rate is based on a words per minute basis: words/line and seconds/line. The length of a word is based on number of characters as described by the width of the div that surrounds it. The length of a line is based on the number of words bounded by the absolute pixel width of the text area. To calculate the length of a line, the lengths of the block-level containers that contain words are summed. The time to read a screen in based on the number of words on the screen. To calculate the time to read a screen, the number of words per screen is multiplied by the rate. The length of time a given line is visible is a ratio of words per line as expressed in pixels and total time to read a screen. In this particular example, the blur is achieved by using built-in properties of the Canvas element's context: globalAlpha=0.65; shadowColor=black (#000); and shadowBlur=20.

### General Computer-Based Implementation

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof.

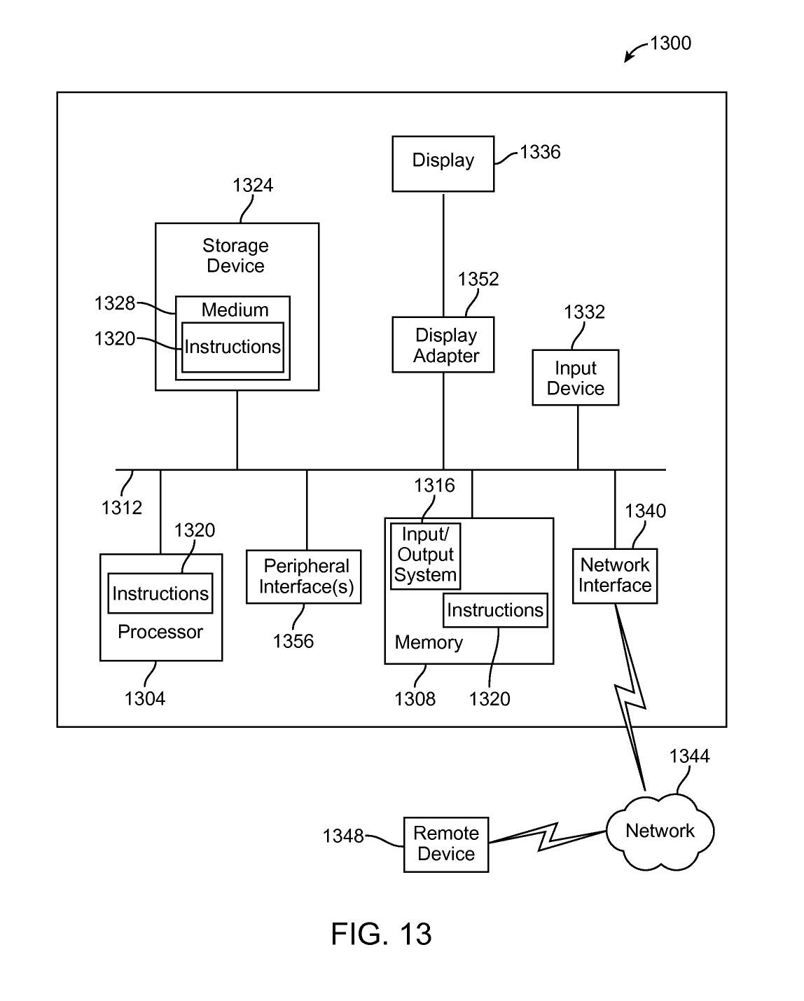

FIG. 13 shows a diagrammatic representation of one embodiment of a computing device in the exemplary form of a computer system 1300 within which a set of instructions for causing the system to perform any one or more of the aspects and/or methodologies of the present disclosure, such as any one or more of the guided window aspects and/or methodologies described above. It is also contemplated that multiple computing devices may be utilized to implement a specially configured set of instructions for causing one or more of the devices to perform any one or more of the aspects and/or methodologies of the present disclosure. Computer system 1300 includes a processor 1304 and a memory 1308 that communicate with each other, and with other components, via a bus 1312. Bus 1312 may include any of several types of bus structures including, but not limited to, a memory bus, a memory controller, a peripheral bus, a local bus, and any combinations thereof, using any of a variety of bus architectures.

Memory 1308 may include various components (e.g., machine readable media) including, but not limited to, a random access memory component, a read only component, and any combinations thereof. In one example, a basic input/output system 1316 (BIOS), including basic routines that help to transfer information between elements within computer system 1300, such as during start-up, may be stored in memory 1308. Memory 1308 may also include (e.g., stored on one or more machine-readable media) instructions (e.g., software) 1320 embodying any one or more of the aspects and/or methodologies of the present disclosure. In another example, memory 1308 may further include any number of program modules including, but not limited to, an operating system, one or more application programs, other program modules, program data, and any combinations thereof.

Computer system 1300 may also include a storage device 1324. Examples of a storage device (e.g., storage device 1324) include, but are not limited to, a hard disk drive, a magnetic disk drive, an optical disc drive in combination with an optical medium, a solid-state memory device, and any combinations thereof. Storage device 1324 may be connected to bus 1312 by an appropriate interface (not shown). Example interfaces include, but are not limited to, SCSI, advanced technology attachment (ATA), serial ATA, universal serial bus (USB), IEEE 11394 (FIREWIRE), and any combinations thereof. In one example, storage device 1324 (or one or more components thereof) may be removably interfaced with computer system 1300 (e.g., via an external port connector (not shown)). Particularly, storage device 1324 and an associated machine-readable medium 1328 may provide nonvolatile and/or volatile storage of machine-readable instructions, data structures, program modules, and/or other data for computer system 1300. In one example, software 1320 may reside, completely or partially, within machine-readable medium 1328. In another example, software 1320 may reside, completely or partially, within processor 1304.

Computer system 1300 may also include an input device 1332. In one example, a user of computer system 1300 may enter commands and/or other information into computer system 1300 via input device 1332. Examples of an input device 1332 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1332 may be interfaced to bus 1312 via any of a variety of interfaces (not shown) including, but not limited to, a serial interface, a parallel interface, a game port, a USB interface, a FIREWIRE interface, a direct interface to bus 1312, and any combinations thereof. Input device 1332 may include a touch screen interface that may be a part of or separate from display 1336, discussed further below. Input device 1332 may be utilized as a user selection device for selecting one or more graphical representations in a graphical interface as described above.

A user may also input commands and/or other information to computer system 1300 via storage device 1324 (e.g., a removable disk drive, a flash drive, etc.) and/or network interface device 1340. A network interface device, such as network interface device 1340, may be utilized for connecting computer system 1300 to one or more of a variety of networks, such as network 1344, and one or more remote devices 1348 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1344, may employ a wired and/or a wireless mode of communication. In general, any network topology may be used. Information (e.g., data, software 1320, etc.) may be communicated to and/or from computer system 1300 via network interface device 1340.

Computer system 1300 may further include a video display adapter 1352 for communicating a displayable image to a display device, such as display device 1336. Examples of a display device include, but are not limited to, a liquid crystal display (LCD), a cathode ray tube (CRT), a plasma display, a light emitting diode (LED) display, and any combinations thereof. Display adapter 1352 and display device 1336 may be utilized in combination with processor 1304 to provide graphical representations of aspects of the present disclosure. In addition to a display device, computer system 1300 may include one or more other peripheral output devices including, but not limited to, an audio speaker, a printer, and any combinations thereof. Such peripheral output devices may be connected to bus 1312 via a peripheral interface 1356. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method of automatically providing reading fluency training to a reader having a reading rate and a reading efficiency, the method comprising:
presenting multiple lines of multiline reading material as a column within a reading frame on an electronic display, wherein the multiline reading material has a reading direction and the column has a column width;
masking the multiple lines of the multiline reading material so as to provide masked reading material; and
moving a guided window through the multiline reading material so as to controllably reveal portions of the masked reading material so as to guide the reader across lines of the reading material at a predetermined speed to develop the reading rate and the reading efficiency of the reader, wherein the guided window has:
a length;
a height that reveals only a single line of the column;
a leading end that moves through the multiline reading material in the reading direction at a leading-end speed; and
a trailing end that is spaced from the leading end to define the length of the guided window, the trailing end moving line by line through the multiline reading material in the reading direction at a trailing-end speed.

2. A method according to claim 1, wherein said presenting multiple lines of multiline reading material includes presenting multiple lines of text.

3. A method according to claim 1, wherein said presenting multiple lines of multiline reading material includes presenting multiple lines of typographical symbols.

4. A method according to claim 1, wherein said presenting multiple lines of typographical symbols includes presenting multiple lines of Landolt rings.

5. A method according to claim 1, further comprising controlling the length of the guided window to be from no less than 10% of the column width to no greater than 60% of the column width.

6. A method according to claim 1, wherein said masking includes masking the multiple lines with a semi-transparent mask so as to deemphasize the masked reading material.

7. A method according to claim 1, wherein the reader is associated with at least one performance measure and said masking includes varying masking transparency in accordance with the at least one performance measure.

8. A method according to claim 1, wherein the reading fluency training is associated with variable instructional objectives and said masking includes adjusting masking color based on the variable instructional objectives.

9. A method according to claim 1, wherein said masking includes blurring the multiple lines so as to deemphasize the masked reading material.

10. A method according to claim 9, wherein the multiple lines contain characters and character strings, said blurring is provided to an extent that only character string shapes and character string spacing is preserved without revealing lexical content.

11. A method according to claim 1, wherein the guided window has a transition speed between lines of the masked reading material, the method further comprising determining the transition speed as a function of position of the guided window within the column of the multiline reading material.

12. A method according to claim 1, wherein the reader has a current reading rate, the method further comprising setting the leading-end speed based on the current reading rate.

13. A method according to claim 1, wherein the multiline reading material has a font size, the method further comprising setting the leading-end speed based on the font size.

14. A method according to claim 1, further comprising setting the leading-end speed based on the length of the guided window.

15. A method according to claim 1, wherein the multiple lines of the multiline reading material have ragged-right justification, the method further comprising transitioning the leading-end from one line to a next line based on the ragged-right justification.

16. A method according to claim 1, wherein the reader is associated with visual and perceptual performance measures, the method further comprising adjusting the length of the guided window as a function of the visual and perceptual performance measures.

17. A method according to claim 1, wherein the reader is associated with a current reading rate, the method further comprising adjusting the length of the guided window as a function of the current reading rate.

18. A method according to claim 1, wherein the multiline reading material has at least one size measure, the method further comprising adjusting the length of the guided window as a function of the at least one size measure.

19. A method according to claim 18, wherein the at least one size measure comprises font size.

20. A method according to claim 19, wherein the at least one size measure further comprises line length.

21. A method according to claim 1, wherein the reader is associated with a reading rate, the method further comprising adjusting font size of the multiline reading material appearing at least in the guided window as a function of the reading rate.

22. A method according to claim 21, wherein the reader has an age, the method further comprising adjusting font size of the multiline reading material appearing at least in the guided window as a function of the reading rate and the age of the reader.

23. A method according to claim 1, further comprising adjusting font size of the multiline reading material appearing at least in the guided window as a function of the length of the guided window.

24. A method according to claim 1, wherein the reader is associated with a current reading rate and an instructional objective, the method further comprising selecting practice content of the multiline reading material as a function of the current reading rate and instructional objective.

25. A method according to claim 1, further comprising:
receiving from the user an indication to pause movement of the guided window; and
in response to said receiving the indication, stopping movement of the guided window and masking all portions of the multiple lines of the multiline reading material within the guided window during the pause.

26. A method according to claim 1, the method further comprising:
receiving from the user an indication to rewind movement of the guided window; and
in response to said receiving the indication, moving the guided window back to a beginning of a previously presented sentence.

27. A method according to claim 1, the method further comprising:
receiving from the user an indication to rewind movement of the guided window; and
in response to said receiving the indication, moving the guided window back a predetermined number of words.

28. A machine-readable storage medium containing machine-executable instructions for performing a method of automatically providing reading fluency training to a reader having a reading rate and a reading efficiency, wherein the method comprises:
presenting multiple lines of multiline reading material as a column within a reading frame on an electronic display, wherein the multiline reading material has a reading direction and the column has a column width;
masking the multiple lines of the multiline reading material so as to provide masked reading material; and
moving a guided window through the multiline reading material so as to controllably reveal portions of the masked reading material so as to guide the reader across lines of the reading material at a predetermined speed to develop the reading rate and the reading efficiency of the reader, wherein the guided window has:
a length;
a height that reveals only a single line of the column;
a leading end that moves through the multiline reading material in the reading direction at a leading-end speed; and
a trailing end that is spaced from the leading end to define the length of the guided window, the trailing end moving line by line through the multiline reading material in the reading direction at a trailing-end speed.
